(19) United States
(12) Patent Application Publication
(10) Pub. No.: US 2009/0115782 A1
(43) Pub. Date: May 7, 2009

(54) Display of Analytic Objects and Geometric Objects

(76) Inventors: Darren Scott Irons, Edmond, OK (US); Charles Bernand Vonder Embse, Shepherd, MI (US); Daniel Richard Gremillion, Fairview, TX (US); Jean-Marie Laborde, St. Sauveur (FR); Pierro Laborde, Grenoble (FR)

Correspondence Address: TEXAS INSTRUMENTS INCORPORATED, P O BOX 655474, M/S 3999, DALLAS, TX, 75265, US

(21) Appl. No.: 11/935,253

(22) Filed: Nov. 5, 2007

(51) Int. Cl. G06T 17/00; G09G 5/00

(52) U.S. Cl. 345/420; 345/619

(57) ABSTRACT

A method and system for simultaneously displaying and manipulating analytic objects and geometric objects on a display is provided. The display includes a coordinate system, such as an x-axis and a y-axis, on which an analytic object is shown. The display also includes a geometric object that is independent of the coordinate system. The scaling of the coordinate system may be altered and the analytic objects are automatically resized accordingly. The analytic objects and the geometric objects may share one or more common points. In this event, the position of the geometric objects may be changed to maintain the relative position and/or shape of the geometric object.

### TECHNICAL FIELD

The present invention relates generally to graphing utilities and, more particularly, to displaying and manipulating analytic and geometric objects on an electronic device.

### BACKGROUND

Electronic calculators have become a common tool for teaching students various aspects of mathematics. In particular, the features of graphing calculators are particularly advantageous in a classroom setting to teach students mathematical principles and to illustrate practical applications of concepts taught in class. In fact, many schools now recommend or require students in math classes to use graphing calculators to aid students in learning about advanced math topics, such as trigonometry and calculus.

Generally, in dynamic geometry software, users, such as students, construct and measure analytic objects or geometric objects, such as lines, polygons, or other shapes and figures. Analytic objects are geometric shapes attached to or constrained by a pre-defined coordinate system having a generic unit of measure, typically referred to generically as “units.” For example, a triangle constructed having vertices at points (1, 2), (8, 9), and (4, 7) in the coordinate plane of a defined coordinate system is an analytic object.

Geometric objects, on the other hand, are geometric shapes constructed in the geometric or Euclidean plane. Geometric objects are generally measured using a known unit of measure such as a physical measurement unit like centimeters or by establishing a representational scaled unit of measure or “key.” For example, a triangle drawn on a screen, without reference to a particular coordinate system, is measured in terms of the key in which it was drawn. The key may be an absolute measurement or a scaled measurement, e.g., one centimeter on the drawn object represents one kilometer.

In certain situations, it is advantageous to study both analytic and geometric objects simultaneously to compare and contrast the objects. Traditional graphing tools, including computers, workstations, graphing calculators, and the associated software, however, only allow a user to construct and analyze one of the analytic or geometric objects at a time, rather than allowing a user to construct both types of objects. That is, on a single display, a user may construct either an analytic object, or a geometric object, but not both. Therefore, there is a need for a system and method to enable a user to construct and/or analyze analytic objects and geometric objects on a single display.

### SUMMARY OF THE INVENTION

These and other problems are generally solved or circumvented, and technical advantages are generally achieved, by preferred embodiments of the present invention which provide a method and a system for displaying analytic objects and graphically-constructed objects on an electronic device.

In an embodiment of the present invention, a method of displaying an analytic object and a geometric object is provided. The method comprises displaying a first object that is linked or associated with a coordinate system. A second object is displayed, but is independent of the coordinate system. Thereafter, the coordinate system may be modified, and the analytic object may be automatically adjusted accordingly. If the analytic object and the geometric object share common points, the position of the geometric object may be modified accordingly such that the shape and/or the relative position of the geometric object remains constant.

In another embodiment of the present invention, a calculator that is capable of displaying an analytic object and a geometric object is provided. The calculator includes a screen capable of displaying text and geometric shapes, a keypad, and a processor communicatively coupled to the display and the keypad. The processor is configured to receive one or more points of an analytic object and to receive one or more points of a geometric object. The processor is further configured to display a coordinate system and the analytic object in addition to the geometric object on the screen.

In another embodiment of the present invention, a computer program product for displaying an analytic object and a geometric object is provided. The computer program product comprises computer program code for receiving one or more points of an analytic object and one or more points of a geometric object. The computer program product further comprises computer program code for generating display data to simultaneously display on a screen the analytic object.

In an embodiment, if the analytic object and the geometric object share common points, the position of the geometric object may be modified by manipulating the analytic object or by changes to the coordinate system such that the shape and/or the relative position of the geometric object changes accordingly.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a block diagram of a handheld computing device in accordance with an embodiment of the present invention;

FIG. 2 illustrates an example of a handheld computing device in accordance with an embodiment of the present invention;

FIG. 3 is a block diagram of a desktop computing device in accordance with an embodiment of the present invention;

FIGS. 4a-4d illustrate examples of a display showing an analytic object and a geometric object in accordance with embodiments of the present invention;

FIG. 5 is a data flow diagram illustrating a method for simultaneously displaying an analytic object and a geometric object in accordance with an embodiment of the present invention; and

FIG. 6 is a data flow diagram illustrating a method for resizing an analytic object in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Embodiments of the present invention are discussed below with respect to embodiments in which a graphing calculator or a personal computer is used. It should be noted, however, that embodiments of the present invention may be useful for other types of electronic devices, handheld computing devices, desktop devices, and mainframe devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, personal communicators, personal intelligent communicators, cellular or mobile telephones, global positioning system (GPS) devices, portable inventory logging computer devices (as may be used by courier deliverers, for example), handheld monitoring devices, handheld portable email devices, handheld portable Internet browsing devices, handheld portable gaming devices, and any combination thereof.

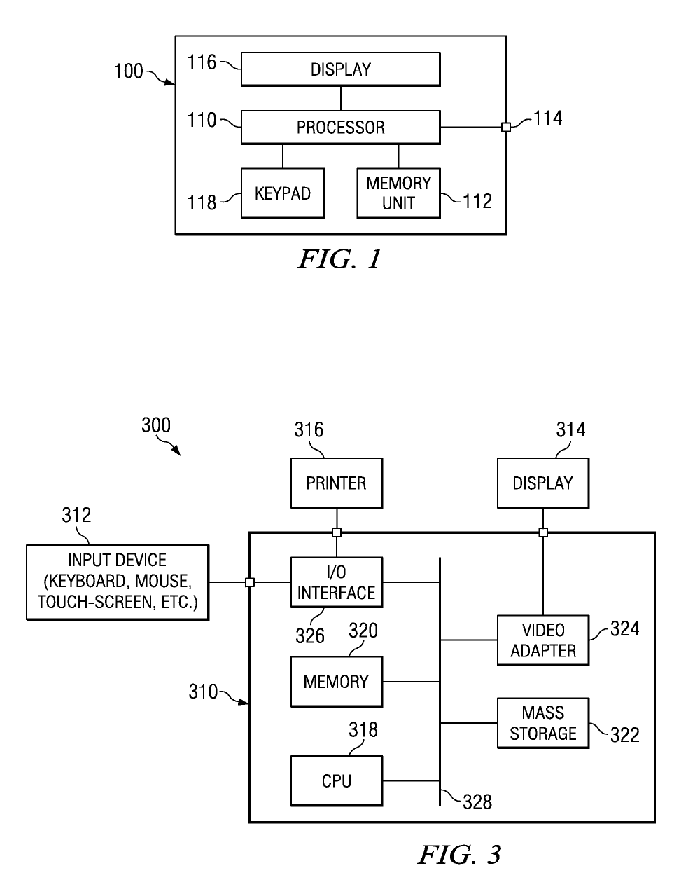

FIG. 1 is a block diagram of a handheld computing device 100 in accordance with an embodiment of the present invention. Generally, the handheld computing device 100 includes a processor 110 connected to a memory unit 112, which may include one or both of read-only memory (ROM) and random-access memory (RAM). In a preferred embodiment, however, the handheld computing device 100 includes ROM to store software programs and RAM to store intermediate data and operating results.

An optional input/output port 114 provides connectivity to other electronic devices, such as other computers, hubs, displays, or the like (not shown). In an embodiment, the input/output port 114 comprises a bi-directional connection such as a mini-A USB port. In this manner, the handheld computing device 100 may transmit information to and receive information from another electronic device (not shown). Also included in the handheld computing device 100 are a display 116 and a keypad 118.

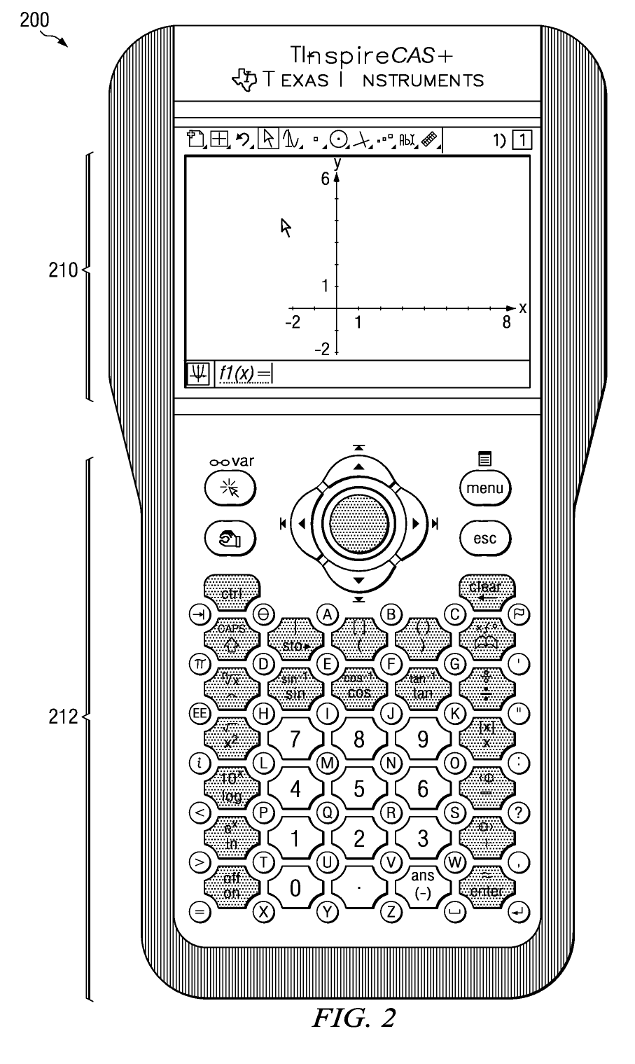

FIG. 2 illustrates an example of the handheld computing device 100 (see FIG. 1) in accordance with an embodiment of the present invention. For illustrative purposes only, the handheld computing device 100 illustrated in FIG. 2 is a graphing calculator 200. It should be noted, however, that the graphing calculator 200 is used for illustrative purposes only and does not limit the invention as claimed.

As shown in FIG. 2, the graphing calculator 200 preferably includes a graphical display 210 and a set of keys 212. Generally, the graphical display 210 provides a means upon which graphs of various functions and/or one or more lines of text/symbols may be displayed. The graphical display 210 may be, for example, an LED or LCD display. The set of keys 212 is located below the graphical display 210 and provides a method for a user, e.g., a student, to enter data and functions. Other configurations and functions may be used.

FIG. 3 is a block diagram of a desktop computing system 300 that may also be used in accordance with an embodiment of the present invention. Generally, embodiments of the present invention may be implemented on devices other than the handheld computing device 100 of FIG. 1 and the graphing calculator 200 of FIG. 2, such as the desktop computing system 300 illustrated in FIG. 3. It should be noted, however, that the desktop computing system 300 discussed herein is provided for illustrative purposes only and that other electronic devices may be used.

The desktop computing system 300 may comprise, for example, a desktop computer, a workstation, a laptop computer, a personal digital assistant, a dedicated unit customized for a particular application, or the like. Accordingly, the components of the desktop computing system 300 disclosed herein are for illustrative purposes only and other embodiments of the present invention may include additional or fewer components.

In an embodiment, the desktop computing system 300 comprises a processing unit 310 equipped with one or more input devices 312 (e.g., a mouse, a keyboard, or the like), and one or more output devices, such as a display 314, a printer 316, or the like. Preferably, the processing unit 310 includes a central processing unit (CPU) 318, memory 320, a mass storage device 322, a video adapter 324, and an I/O interface 326 connected to a bus 328. The bus 328 may be one or more of any type of several bus architectures including a memory bus or memory controller, a peripheral bus, video bus, or the like. The CPU 318 may comprise any type of electronic data processor. For example, the CPU 318 may comprise a Pentium™ processor from Intel Corp., an Athlon™ processor from Advanced Micro Devices, Inc., a Reduced Instruction Set Computer (RISC), an Application-Specific Integrated Circuit (ASIC), or the like. The memory 320 may comprise any type of system memory such as static random access memory (SRAM), dynamic random access memory (DRAM), synchronous DRAM (SDRAM), read-only memory (ROM), a combination thereof, or the like. In an embodiment, the memory 320 may include ROM for use at boot-up, and DRAM for data storage for use while executing programs.

The mass storage device 322 may comprise any type of storage device configured to store data, programs, and other information and to make the data, programs, and other information accessible via the bus 328. In a preferred embodiment, the mass storage device 322 is configured to store the emulation program to be executed by the CPU 318. The mass storage device 322 may comprise, for example, one or more of a hard disk drive, a magnetic disk drive, an optical disk drive, or the like.

The video adapter 324 and the I/O interface 326 provide interfaces to couple external input and output devices to the processing unit 310. As illustrated in FIG. 3, examples of input and output devices include the display 314 coupled to the video adapter 324 and the mouse/keyboard 312 and the printer 316 coupled to the I/O interface 326. Other devices may be coupled to the processing unit 310.

It should be noted that the handheld computing device 100 and the desktop computing system 300 may include other components. For example, the handheld computing device 100 and the desktop computing system 300 may include power supplies, cables, a motherboard, removable storage media, cases, a network interface, and the like. These other components, although not shown, are considered part of the handheld computing device 100 and the desktop computing system 300.

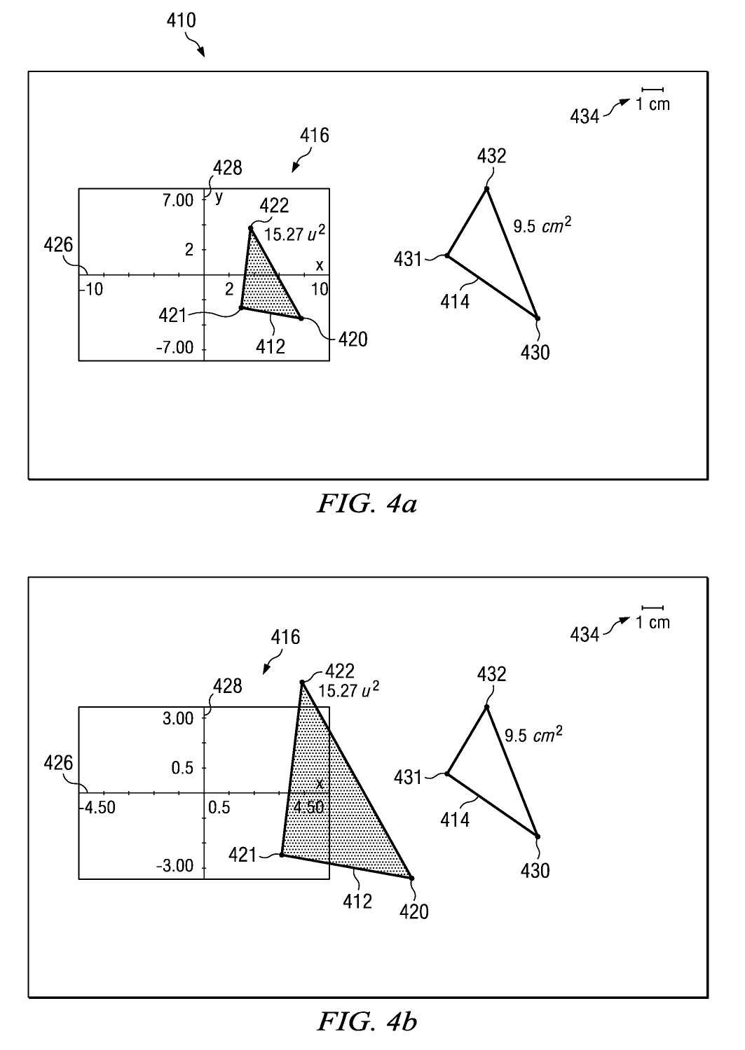

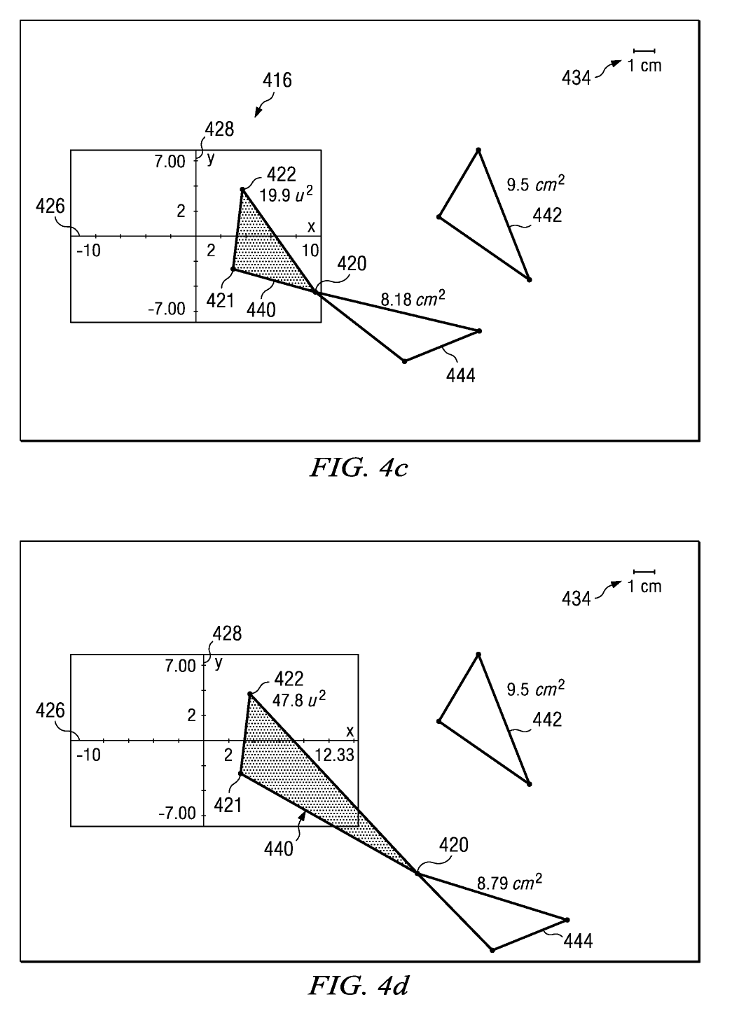

FIGS. 4a-4d are example screen shots of simultaneously displaying analytic objects and geometric objects on a display, such as the display 116 of FIG. 1 or the display 314 of FIG. 3 in accordance with embodiments of the present invention. Referring first to FIG. 4a, a display 410 is shown having an analytic object 412 and a geometric object 414 displayed thereon. As discussed above, an analytic object, such as the analytic object 412, comprises geometric shapes attached or associated with an analytic coordinate system or grid, such as a grid 416, and a geometric object, such as the geometric object 414, comprises geometric shapes constructed in a plane and is not associated with the grid 416. A geometric object may also be referred to as a Euclidean object created in Euclidean space.

As illustrated in FIG. 4a, the analytic object 412 comprises a triangle having three vertices 420-422 on the grid 416, wherein the grid 416 comprises an x-axis 426 and a y-axis 428. Each of the x-axis 426 and the y-axis 428 has units identified by hash marks evenly spaced apart, thereby identifying a generic unit of measure. Locations and measurements of the analytic object 412 are determined relative to the units of the grid 416. For example, as illustrated in FIG. 4a, the location of the three vertices 420-422, the length of the sides, and the area of the analytic object 412 are determined relative to the grid 416. In FIG. 4a, the area of the analytic object 412 is displayed. In other embodiments, other locations or distances may be labeled, such as the vertices, sides, medians, centroid, bisectors, and the like.

In contrast, the geometric object 414 is not attached to the analytic coordinate system and, therefore, are not constrained by the analytic coordinate system. For example, points 430-432 in FIG. 4a represent vertices of a triangle, but are not constrained by the analytic coordinate system, e.g., the grid 416. A key, such as key 434 illustrated in FIG. 4a, may be used to assign a given length a predetermined unit of measure. The key may have an implied default length, such as 1 cm=1 cm. Numerical attributes of the geometric object 414, such as an area, lengths, and the like, may be calculated and/or displayed relative to the key 434. In the current example, an area is determined and displayed. However, one of ordinary skill in the art will realize that other values may also be determined and/or displayed.

Preferably, the analytic object 412 and the geometric object 414 are initially drawn automatically establishing the points that define the object or manually by using an input device, such as the keypad 212 of FIG. 2, the input device 312 of FIG. 3, or the like. In an embodiment in which the analytic object 412 and the geometric object 414 are manually drawn, a function key is depressed that identifies the entered shape as either an analytic object or a geometric object.

FIG. 4b illustrates the analytic object 412 and the geometric object 414 of FIG. 4a after adjusting the scaling of the grid 416. In particular, the grid 416 was expanded such that the grid 416 ranges from +/−4.50 along the x-axis 426 and +/−3.00 along the y-axis 428 in FIG. 4b, as opposed to the grid 416 ranging from +/−10 along the x-axis 426 and +/−7.00 along the y-axis 428 in FIG. 4a. It should be noted that while FIG. 4b illustrates an example in which both the x-axis 426 and the y-axis 428 are expanded, embodiments of the present invention allow for the axes to be modified independently of each other. For example, one axis may be reduced while the other is left unchanged or expanded or the like.

It should also be noted that the analytic object 412 is adjusted automatically upon the adjustment of the grid 416. In this example, the grid 416 was expanded such that the analytic object 412 is partially outside of the grid 416. In a preferred embodiment, the size of the grid 416 is irrelevant and conceptually expands to infinity in all directions. Accordingly, points of the analytic object 412 outside of the grid 416 are nonetheless associated with the grid 416 and measurements of the analytic object 412 are derived from the grid 416 and the scale of the x-axis 426 and the y-axis 428. Furthermore, because the size of the analytic object 412 is adjusted automatically with reference to the adjustments in the grid, the relative locations, sizes, and areas of the analytic object 412 remain constant.

It should also be noted that the adjustment of the grid 416 has no effect on the geometric object 414, which is not attached or associated with the grid 416.

FIG. 4c illustrates another embodiment of the present invention in which an analytic object and a geometric object share one or more points. In FIG. 4c, an analytic object 440 and a first geometric object 442 corresponding to the analytic object 412 and the geometric object 414, respectively, of FIG. 4a is shown, wherein like reference numerals refer to like elements. In addition, a second geometric object 444 is illustrated having a common point with the analytic object 440. In particular, vertex 420 is a vertex of both the analytic object 440 and the second geometric object 444.

One of ordinary skill in the art will appreciate that because the second geometric object 444 is geometric in the Euclidean space as opposed to being analytic with reference to the grid 416, the measurements, such as lengths, area, and the like, are determined and/or displayed using the key 434. In a preferred embodiment, if at least one point is constructed in the Euclidean space, then the object is considered a geometric object.

FIG. 4d illustrates the analytic object 440, the first geometric object 442, and the second geometric object 444 of FIG. 4c after adjusting the grid 416, wherein like reference numerals refer to like elements. It should be noted that because the analytic object 440 is the only shape attached to the grid 416, the analytic object 440 is the only shape to change size due to the adjustment of the grid 416. In particular, it should be noted that it is preferred that the shape of the second geometric object 444 is not altered as a result of the adjustment to the grid 416 even though the second geometric object 444 has a common point with the analytic object 440, i.e., the vertex 420. While the shape and size of the second geometric object 444 has remained constant, one of ordinary skill in the art will realize that the position has changed due to the translation in the position of the vertex 420. By changing the position of the second geometric object 444, the relative positions of the other vertices of the second geometric object 444 remain constant as well as the measurements.

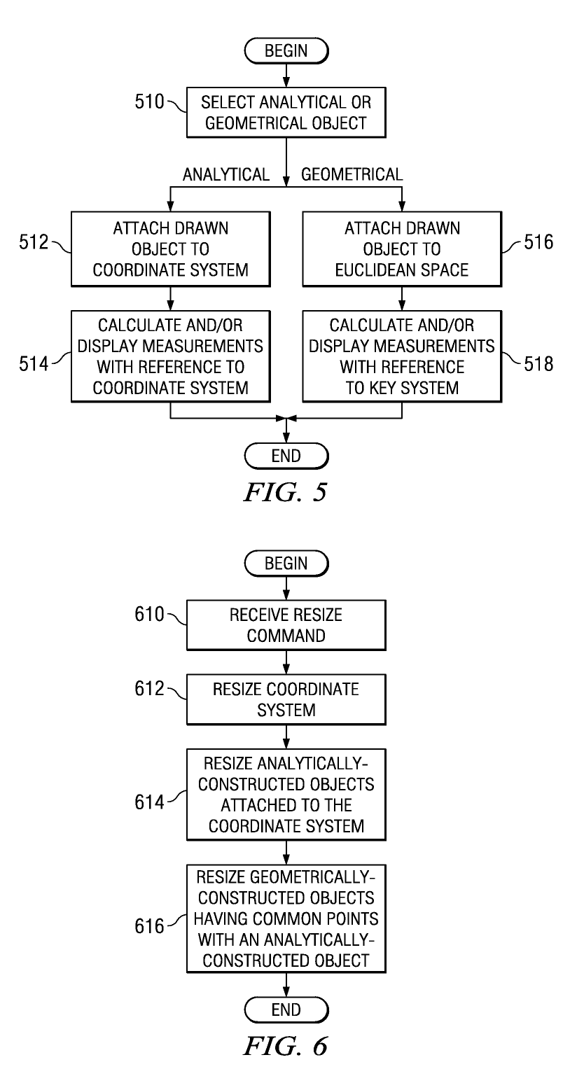

FIG. 5 is a flow diagram illustrating a method for creating and displaying an analytic object and a geometric object in accordance with an embodiment of the present invention. The process begins in step 510, wherein a determination is made whether the object being drawn is selected as an analytic object or a geometric object. It should be noted that while the flow diagram is illustrated as a branch dependent upon the selection between an analytic object or a geometric object, it should be understood that embodiments of the present invention allow for the simultaneous display of an analytic object and a geometric object. Accordingly, the process described in FIG. 5 is preferably performed for each object drawn on a display.

Upon making a determination in step 510 that an analytic object is being drawn, the process proceeds to step 512, wherein the object is attached to the current coordinate system. Thereafter, in step 514, the relevant measurements may be determined based upon the pixel location of the object and the coordinate system. One or more of these measurements may be displayed.

If in step 510 a determination is made that a geometric object is being drawn, then the process proceeds to step 516 wherein the object is attached to the Euclidean space. Thereafter, in step 518, the relevant measurements are determined based upon the pixel location of the object and the key system. One or more of these measurements may be displayed.

FIG. 6 is a flow diagram illustrating a method for resizing analytic objects in accordance with an embodiment of the present invention. The process begins in step 610 wherein a resize command is received. The resize command may include a command to resize one or both of the axes, and may include a command to increase or decrease the axis associated with the command.

Next, in step 612, the coordinate system is resized, which includes increasing or decreasing the scale of the axes in accordance with the command. Thereafter, the analytic objects attached or associated with the coordinate system is resized in step 614, such as that described above with reference to FIG. 4b.

In step 616, geometric objects having one or more common points with an analytic object are repositioned as necessary. As discussed above with reference to FIGS. 4c and 4d, geometric objects and analytic objects may have one or more common points. In this event, it is preferred that the geometric object be repositioned such that the shape remains constant and/or relative positions of the uncommon points to the common points remain constant.

It should be noted that all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, a hardware system may be specifically designed to perform one or more of the functions described herein.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for displaying objects on an electronic device, the method comprising:
displaying a first object on a display, the first object being an analytic object associated with a coordinate system;
linking the first object with the coordinate system; and
displaying a second object on the display, the second object being a geometric object independent of the coordinate system.

2. The method of claim 1, further comprising resizing the coordinate system.

3. The method of claim 2, wherein the resizing the coordinate system includes resizing the first object accordingly and the second object remaining unchanged.

4. The method of claim 1, wherein the first object and the second object share at least one common point.

5. The method of claim 4, further comprising resizing the coordinate system, the resizing including resizing the first object such that the at least one common point is repositioned in accordance with the resizing of the coordinate system, uncommon points of the second object being repositioned to maintain relative positions from the at least one common point.

6. The method of claim 1, further comprising displaying one or more values regarding the first object with reference to the coordinate system, and displaying one or more values regarding the second object with reference to a key system.

7. The method of claim 1, further comprising classifying an object as a geometric.

8. A calculator comprising:
a screen capable of displaying geometric shapes and text;
a keypad having a plurality of keys; and
a processor communicatively coupled to the screen and the keypad, the processor being configured to:
receive one or more first points of an analytic object;
receive one or more second points of a geometric object;
display on the screen a coordinate system and the analytic object; and
display on the screen the geometric object.

9. The calculator of claim 8, wherein the processor is further configured to receive a resize command and to resize the coordinate system in accordance with the resize command, the resize including modifying the analytic object accordingly.

10. The calculator of claim 9, wherein the processor is further configured maintain a constant display of the geometric object when resizing the coordinate system and the analytic object.

11. The calculator of claim 8, wherein the one or more second points of the geometric object and the one or more first points of the analytic object have one or more common points.

12. The calculator of claim 8, wherein the processor is configured to resize the analytic object upon receipt of a resize command.

13. The calculator of claim 12, wherein the analytic object and the geometric object share one or more common points and the processor is configured to reposition the geometric object to maintain a relative distance between the one or more common points and remaining points of the geometric object.

14. The calculator of claim 8, wherein the processor is further configured to display a key system and one or more values of the geometric object.

15. A computer program product for displaying an analytic object and a geometric object, the computer program product having a medium with a computer program embodied thereon, the computer program comprising:
computer program code for receiving one or more points of an analytic object;
computer program code for receiving one or more points of a geometric object; and
computer program code for generating display data to simultaneously display on a screen the analytic object with an associated coordinate system and the geometric object.

16. The computer program product of claim 15, further comprising computer program code for receiving a coordinate resize command and computer program code for resizing the coordinate system and the analytic object in accordance with the resize command.

17. The computer program product of claim 16, wherein the geometric object remains constant when the analytic object is resized.

18. The computer program product of claim 15, wherein the analytic object and the geometric object have one or more common points.

19. The computer program product of claim 18, further comprising:
computer program code for receiving a resize command;
computer program code for resizing the analytic object in accordance with the resize command; and
computer program code for repositioning the geometric object such that a relative position between uncommon points of the geometric and the one or more common points remain constant.

20. The computer program product of claim 15, further comprising computer program code for computing and displaying one or more measurements for the analytic object relative to the associated coordinate system and computing and displaying one or more measurements for the geometric object relative to a key.
